(19) United States
(12) Patent Application Publication
(10) Pub. No.: US 2025/0370179 A1
(43) Pub. Date: Dec. 4, 2025

(54) OPTICAL FIBER GENERATING IN USE A PHYSICAL UNCLONABLE FUNCTION, OBJECT EQUIPPED THEREWITH, AND APPARATUS FOR MANUFACTURING THEREOF

(71) Applicant: POLYVALOR, LIMITED PARTNERSHIP, QUEBEC (CA)

(72) Inventors: Raman KASHYAP, BAIE d'URFE (CA); Frederic MONET, MONTREAL (CA)

(73) Assignee: POLYVALOR, LIMITED PARTNERSHIP, QUEBEC, QC (CA)

(21) Appl. No.: 18/874,221

(22) PCT Filed: Jun. 28, 2023
(86) PCT No.: PCT/CA2023/050887

§ 371 Date: Dec. 12, 2024

Related U.S. Application Data
(60) Provisional application No. 63/357,657, filed on Jul. 1, 2022.

(30) Foreign Application Priority Data
Jun. 28, 2023 (WO) PCT/CA2023/050887

(51) Int. Cl. G02B 6/02; H04B 10/85; H04L 9/32

(52) U.S. Cl. CPC G02B 6/02066; G02B 6/0229; H04B 10/85; H04L 9/3278; H04L 2209/12

(57) ABSTRACT

There is described an optical fiber comprising a core with non-fungible noise elements along a length thereof, wherein the non-fungible noise elements generate in use a Physical Unclonable Function (PUF). There is further described an object including the present optical fiber and uses of the present optical fiber in applications such as authentication, encryption and zero trust security. There is also described an apparatus for introducing non-fungible noise elements along a core of a bundled optical fiber, a method for extracting a digital signature of a Physical Unclonable Function (PUF) generated by introduced non-fungible noise elements in the present optical fiber and a network integrating the present optical fiber.

### TECHNICAL FIELD

The present disclosure relates to the field of optical fiber generating in use a physical unclonable function (PUF), objects incorporating such optical fiber and to an apparatus for manufacturing such an optical fiber.

### BACKGROUND

Concerns are ever-growing about security and privacy as communications systems and technologies evolve. Most communications are now made online, and as such risks of potential eavesdropping and hacking. There is therefore a real drive to develop novel techniques to authenticate a user's identity to protect secure information by communicating the secure information only to authorized recipients, to prevent eavesdroppers and identity frauds. Many devices have been developed to address such challenges, for instance passwords [R. Morris and K. Thompson, “Password security: A case history,” Communications of the ACM, vol. 22, no. 11, pp. 594-597, 1979], barcodes [T. Sriram, K. V. Rao, S. Biswas, and B. Ahmed, “Applications of barcode technology in automated storage and retrieval systems,” in Proceedings of the 1996 IEEE IECON. 22nd International Conference on Industrial Electronics, Control, and Instrumentation, 1996, vol. 1: IEEE, pp. 641-646.], quick response (QR) codes [K. Krombholz, P. Frühwirt, P. Kieseberg, I. Kapsalis, M. Huber, and E. Weippl, “QR code security: A survey of attacks and challenges for usable security,” in International Conference on Human Aspects of Information Security, Privacy, and Trust, 2014: Springer, pp. 79-90] and radio-frequency identification (RFID) [A. Juels, “RFID security and privacy: A research survey,” IEEE journal on selected areas in communications, vol. 24, no. 2, pp. 381-394, 2006], to only name a few.

While passwords are certainly the most used authentication method, passwords can be leaked and are susceptible to human error (e.g., forgetting the password, choosing weak easily guessed password, etc.). Barcodes and QR codes are both ways to represent binary data by a succession of white and black lines (or squares), in a linear format for the barcode and 2D for the QR code. While barcodes and QR codes have a large data capacity (especially the QR code), they can be easily scanned and reproduced by any determined third party [Y.-J. Tu, W. Zhou, and S. Piramuthu, “Critical risk considerations in auto-ID security: Barcode vs. RFID,” Decision Support Systems, vol. 142, p. 113471, 2021]. For those reasons, barcodes and QR codes are not typically used for authentication of secure information, and are limited to more mundane tasks (e.g., checkout at grocery stores).

RFID systems are based on data transmitted through electromagnetic waves; a digital reader scans an RFID tag, which can be either passive or active microchips, to authenticate the identity of a carrier, or of an attached item [A. Juels, “RFID security and privacy: A research survey,” IEEE journal on selected areas in communications, vol. 24, no. 2, pp. 381-394, 2006]. The RFID tag is heavily used in multiple industries, both to allow employees to authenticate their identity for access to facilities, as well as for identifying shipment of goods. However, RFID tags are vulnerable to external interference, and can be replicated, meaning that a third party could clone an RFID tag to impersonate an authorized carrier [Y.-J. Tu, W. Zhou, and S. Piramuthu, “Critical risk considerations in auto-ID security: Barcode vs. RFID,” Decision Support Systems, vol. 142, p. 113471, 2021]. Therefore, RFID tags are typically not sufficiently secure for high-security applications.

Physical Unclonable Functions (PUFs) are hardware-based systems that have received considerable attention in recent years. PUFs are based on noise and randomness inherent to their fabrication process, making each PUF unique [R. Pappu, B. Recht, J. Taylor, and N. Gershenfeld, “Physical one-way functions,” Science, vol. 297, no. 5589, pp. 2026-2030, 2002]. Since PUFs are based on random variations, PUFs are impossible to reproduce, even when knowing the manufacturing process and desired output signal. This non-reproducibility makes PUFs well suited for authentication purposes, as they are unique and irreproducible, and can therefore act as a hardware fingerprint, ensuring the identity of its carrier [Y. Gao, S. F. Al-Sarawi, and D. Abbott, “Physical unclonable functions,” Nature Electronics, vol. 3, no. 2, pp. 81-91, 2020].

Two types of PUFs have been proposed: electronics-based or silicon PUFs, static random-access memory (SRAM) PUFs and optical PUFs. Electronics-based or silicon PUFs are discussed in the publication by B. Gassend, D. Clarke, M. Van Dijk, and S. Devadas, “Silicon physical random functions,” in Proceedings of the 9th ACM Conference on Computer and Communications Security, 2002, pp. 148-160], while static random access memory (SRAM) PUFs were discussed in [J. Guajardo, S. S. Kumar, G.-J. Schrijen, and P. Tuyls, “FPGA intrinsic PUFs and their use for IP protection,” in International workshop on cryptographic hardware and embedded systems, 2007: Springer, pp. 63-80].

Optical PUFs are based on optical and photonic techniques to probe intrinsically random systems. For instance, during the cold war, thin coatings of reflecting particles were sprayed on nuclear weapons [S. N. Graybeal and P. B. McFate, “Getting out of the STARTing block,” Scientific American, vol. 261, no. 6, pp. 61-67, 1989]. Since the reflecting particles were randomly distributed on surfaces, the interference pattern they generated when illuminated was unique and unpredictable, allowing them to be identified precisely.

Other optical PUF were proposed over the years, for example relying on plasmonic nanoparticles [A. F. Smith, P. Patton, and S. E. Skrabalak, “Plasmonic nanoparticles as a physically unclonable function for responsive anti-counterfeit nanofingerprints,” Advanced Functional Materials, vol. 26, no. 9, pp. 1315-1321, 2016], or laser speckle measurements [C.-H. Yeh, P.-Y. Sung, C.-H. Kuo, and R.-N. Yeh, “Robust laser speckle recognition system for authenticity identification,” Opt. Express, vol. 20, no. 22, pp. 24382-24393, 2012].

Recently, optical fiber-based PUFs have shown potential for next-generation authentication applications, due to their low cost, relaxed requirements on optical alignment, and the fact that fiber optics are already integral components of many networks. For example, Mesaritakis et al. presented an optical fiber-based PUF relying on the speckle response of a multimode polymer optical fiber that could be interrogated from multiple angles and wavelengths [C. Mesaritakis et al., “Physical unclonable function based on a multi-mode optical waveguide,” Scientific reports, vol. 8, no. 1, pp. 1-12, 2018].

PUFs are characterized by a combination of input challenge and corresponding output response, a process known as challenge-response pair (CRP) [Y. Gao, S. F. Al-Sarawi, and D. Abbott, “Physical unclonable functions,” Nature Electronics, vol. 3, no. 2, pp. 81-91, 2020]. PUFs are categorized based on their CRP domain, which is the number of unique challenges the PUF can support while outputting a different unique response. A weak PUF has only one or a few CRPs, while a strong PUF has a CRP domain large enough that its entire measurement cannot be completed in a reasonable timeframe.

Weak PUFs are typically used for cryptographic key generation, which can then be used for multiple cryptographic protocols such as authentication and encryption [C. Herder, M.-D. Yu, F. Koushanfar, and S. Devadas, “Physical unclonable functions and applications: A tutorial,” Proceedings of the IEEE, vol. 102, no. 8, pp. 1126-1141, 2014]. Some examples of weak PUF architectures include SRAM PUFs [J. Guajardo, S. S. Kumar, G.-J. Schrijen, and P. Tuyls, “FPGA intrinsic PUFs and their use for IP protection,” in International workshop on cryptographic hardware and embedded systems, 2007: Springer, pp. 63-80] [Y. Su, J. Holleman, and B. Otis, “A 1.6 pJ/bit 96% stable chip-ID generating circuit using process variations,” in 2007 IEEE International Solid-State Circuits Conference. Digest of Technical Papers, 2007: IEEE, pp. 406-611] and ring-oscillator PUFs [G. E. Suh and S. Devadas, “Physical unclonable functions for device authentication and secret key generation,” in 2007 44th ACM/IEEE Design Automation Conference, 2007: IEEE, pp. 9-14] and [A. Maiti and P. Schaumont, “Improved ring oscillator PUF: An FPGA-friendly secure primitive,” Journal of cryptology, vol. 24, no. 2, pp. 375-397, 2011].

Strong PUFs can be used for the same applications as weak PUFs, but are further adapted for more stringent applications such as oblivious transfer and multi-party computation [Y. Gao, S. F. Al-Sarawi, and D. Abbott, “Physical unclonable functions,” Nature Electronics, vol. 3, no. 2, pp. 81-91, 2020] and [U. Rührmair and M. van Dijk, “On the practical use of physical unclonable functions in oblivious transfer and bit commitment protocols,” Journal of Cryptographic Engineering, vol. 3, no. 1, pp. 17-28, 2013] [C. Brzuska, M. Fischlin, H. Schröder, and S. Katzenbeisser, “Physically uncloneable functions in the universal composition framework,” in Annual Cryptology Conference, 2011: Springer, pp. 51-70].

Furthermore, many methods have been developed to offer robust PUF performance in the presence of noise and environmental fluctuations [M.-D. Yu and S. Devadas, “Secure and robust error correction for physical unclonable functions,” IEEE Design & Test of Computers, vol. 27, no. 1, pp. 48-65, 2010]. The simplest solutions either allow a certain error tolerance on the measurement [B. Gassend, D. Clarke, M. Van Dijk, and S. Devadas, “Silicon physical random functions,” in Proceedings of the 9th ACM Conference on Computer and Communications Security, 2002, pp. 148-160], offer multiple authentication opportunities before rejecting the PUF, or use both these techniques simultaneously [C. Herder, M.-D. Yu, F. Koushanfar, and S. Devadas, “Physical unclonable functions and applications: A tutorial,” Proceedings of the IEEE, vol. 102, no. 8, pp. 1126-1141, 2014].

The PUF architecture proposed by Du et al., relies on intrinsic Rayleigh backscatter of an optical fiber [Y. Du, S. Jothibasu, Y. Zhuang, C. Zhu, and J. Huang, “Unclonable optical fiber identification based on Rayleigh backscattering signatures,” Journal of Lightwave Technology, vol. 35, no. 21, pp. 4634-4640, 2017]. By scanning a standard telecommunications optical fiber using optical frequency domain reflectometry (OFDR), Du et al. showed that an algorithm would generate a unique response from a short piece of fiber that could be readily identified and authenticated, based on the random and distributed Rayleigh backscatter of the fiber, originating from minor density fluctuations randomly occurring in the optical fiber due to irregular microscopic structure. However, the weakness of the scanned signal required the use of a custom high sensitivity interrogator.

A technique to increase a backscattered signal in optical fibers, by inscribing Random Optical Gratings by Ultraviolet or ultrafast laser Exposure (ROGUEs) has been previously proposed [F. Monet, S. Loranger, V. Lambin-lezzi, A. Drouin, S. Kadoury, and R. Kashyap, “The ROGUE: a novel, noise-generated random grating,” Opt. Express, vol. 27, no. 10, pp. 13895-13909, 2019 May 13 2019, doi: 10.1364/OE.27.013895]. The ROGUE optical fiber tested provided an increase of the backscattered signal by up to 50 dB, significantly increasing signal to noise ratio (SNR) of OFDR measurements. While the ROGUE optical fiber was developed for distributed sensing applications [F. Monet et al., “High-resolution optical fiber shape sensing of continuum robots: A comparative study,” in 2020 IEEE International Conference on Robotics and Automation (ICRA), 2020: IEEE, pp. 8877-8883], these publications proved that ROGUE optical fibers generate a unique and irreproducible signal.

There is a need for an improved optical fiber for generating a physical unclonable function (PUF), objects incorporating such optical fiber and to an apparatus for manufacturing such an optical fiber.

### SUMMARY

According to a first aspect, the present disclosure relates to an optical fiber comprising a core including non-fungible noise elements along a length thereof, wherein the non-fungible noise elements generate in use a Physical Unclonable Function (PUF).

According to a particular aspect, the present disclosure relates to an optical fiber wherein the non-fungible noise elements comprise at least one of: non-fungible grating inscriptions, enhanced scatter through laser exposure and enhanced scatter through nanoparticles doping.

According to another particular aspect, the present disclosure relates to an optical fiber wherein the non-fungible grating inscriptions and the enhanced scatter through laser exposure are introduced by one of a UV laser or femtosecond laser,

According to another particular aspect, the present optical fiber is one of the following: a single mode optical fiber or a multi-mode optical fiber.

According to another particular aspect of the present optical fiber, the non-fungible noise elements are introduced to the core by Random Optical Gratings by Ultraviolet or ultrafast laser Exposure (ROGUE) interference pattern.

According to another particular aspect of the present optical fiber, ROGUE interference pattern is introduced by at least one of: a Talbot interferometer, behind a phase mask and point-by-point inscription.

According to another particular aspect of the present optical fiber, the ROGUE interference pattern is introduced using one of a UV laser and a femtosecond laser.

According to another particular aspect of the present optical fiber, the optical fiber is a telecommunications optical fiber.

According to another particular aspect of the present optical fiber, a 10 mm optical fiber section generates one PUF.

According to a second aspect, the present disclosure relates to an object including the present optical fiber.

According to a third aspect, the present disclosure relates to uses Use of the present optical fiber for any of the following applications: authentication, encryption and zero trust security.

According to a fourth aspect, the present disclosure relates to an apparatus for introducing non-fungible noise elements along a core of a bundled optical fiber. The apparatus comprising a laser, an interferometer, a pair of mirrors, a pair of optical fiber clamps and a stepper motor. The laser generates a light signal. The interferometer splits the light signal into two concurrent light beams. The pair of mirrors redirects the two concurrent light beams to form a ROGUE interference pattern. One of the optical fiber clamps is positioned before the ROGUE interference pattern and the other optical fiber clamp is positioned after the ROGUE interference pattern. The pair of optical fiber clamps allowing sliding of the optical fiber along a pulling direction while maintaining the optical fiber located between the pair of optical fiber clamps at a focal spot of the ROGUE interference pattern. The stepper motor pulls the optical fiber through the pair of clamps.

According to a particular aspect of the apparatus, the laser is one of an ultraviolet laser and a femtosecond laser.

According to a particular aspect of the apparatus, a central wavelength of the ROGUE interference pattern is tuned by changing an angle of intersection of the two light beams.

According to a fifth aspect, the present disclosure relates to a method for extracting a digital signature of a Physical Unclonable Function (PUF) generated by introduced non-fungible noise elements in an optical fiber. The method includes injecting light in the optical fiber and scanning a frequency spectrum. The method further includes collecting light reflected by the non-fungible noise elements of the optical fiber. The method then proceeds to extracting a digital signature for the PUF by computing derivative of the collected light over the scanned spectrum and attributing a 0 or a 1 depending on the sign of the derivative thereby converting the scanned frequency spectrum into the digital signature.

According to a sixth aspect, the present disclosure relates to a network comprising an optical fiber for transmitting data between a transmitter and a receiver, at least one section of the optical fiber including non-fungible noise elements which generate when the optical fiber is in use at least one Physical Unclonable Functions (PUFs) and a PUFs database, the database including a list of identified PUFs along the section of optical fiber, and receiver information for the assigned PUFs on the list.

According to a particular aspect, the network further comprises an optical splitter for distributing PUF encrypted signals to appropriate receivers.

### BRIEF DESCRIPTION OF THE DRAWINGS

Embodiments of the disclosure will be described by way of example only with reference to the accompanying drawings, in which:

FIG. 1 is an example network including a PUF architecture.

FIG. 2 illustrates an apparatus for continuous ROGUE writing of an optical fiber.

FIG. 3 illustrates ROGUE backscatter signal both shown (a) in spatial domain, where an improvement in backscattered signal of 20 dB above the unexposed fiber can be observed, and (b) in spectral domain, where the random structure of the backscattered spectrum is shown, as well as its broad 12 nm full width at first zeros (FWFZ) bandwidth.

FIG. 4 illustrates PUF generation algorithm, displayed over a 2 nm bandwidth. From an initial spectrum (a), a discrete derivative is applied, resulting in a signal (b). Positive derivatives are attributed a “1” bit (red), and negative derivatives a “0” bit (blue), resulting in a bit signature shown in (c). A first 100 PUF bit signatures thus generated are displayed in (d), with the “1” bits displayed in red and “0” bits in blue.

FIG. 5 illustrates Hamming Distance distributions, for both (a) a ROGUE-inscribed PUFs and (b) a telecommunication optical fiber (TF) PUFs. In both cases, the intra distribution is shown in blue, while the inter distribution is in orange. Binomial distribution fits were applied to all the distributions, are displayed in dashed lines.

FIG. 6 illustrates false positive and false negative probabilities, depending on the detection threshold, for both (a) the ROGUE-inscribed PUFs and (b) the TF PUFs. False positive probabilities are in blue, while false negative probabilities are in orange.

FIG. 7 illustrates probability of false identification for the ROGUE PUFs, for different PUF lengths and scanned bandwidth. The face color is interpolated from the experimental data points (black squares).

FIG. 8 illustrates (a) Fitted binomial p values for both intra (blue) and inter (orange) distributions, for each of the bits of the 64-bit double representation, for L=20 mm. Only bits 5 to 25 are shown, although the behavior observed extends on both sides. The dashed line identifies the threshold at which the inter distribution reaches p=0.50±0.02. (b) False identification probability P_{FI} depending on the digitization used, for the first three PUF lengths, with the 5.24 nm scanned bandwidth. The star marker is the probability computed using the derivative algorithm described in section II.B.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address optical fiber with non-fungible gratings, a method for fabricating such an optical fiber and apparatus for fabricating such an optical fiber.

The following terminology is used throughout the present disclosure:
CRP: Challenge-Response pair
FBG: Fiber Bragg Grating
OFDR: Optical Frequency Domain Reflectometry
PUF: Physical Unclonable Function. PUFs are physical devices exploiting intrinsic randomness properties of components introduced during their fabrication. PUFs can be used for authentication and secure key generation applications,
ROGUE: Random Optical Gratings by Ultraviolet or ultrafast laser Exposure
TF: Telecommunications optical Fiber

The present disclosure relates to the field of optical fiber with non-fungible noise elements for generating in use a physical unclonable function (PUF), objects incorporating such optical fiber and to an apparatus for manufacturing such an optical fiber.

### Optical Fiber With Non-Fungible Noise Elements

Optical fibers are developed based on the optical characteristics required in operation. Telecommunications optical Fibers (TF) are a specific type of optical fiber with characteristics to transport large volume of data, large number of communications if needed on long distances.

Optical fibers are also suitable for other applications, when their optical characteristics are modified to expand their scope of applications.

The present optical fiber includes a core characterized by non-fungible noise elements. The non-fungible noise elements are introduced to the core through gratings inscriptions (either UV or femtosecond laser inscribed), scatter inscriptions (either UV or femtosecond laser inscribed) or doping, either used separately or in combination. The non-fungible noise elements of the present optical fiber, in use, provide at least one Physical Unclonable Function (PUF).

### Network With PUF Architecture

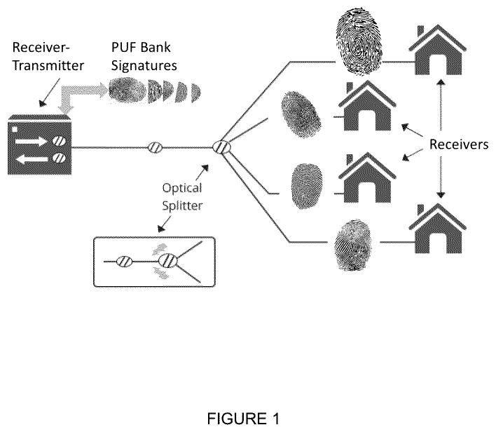

Reference is made to FIG. 1 which illustrates an exemplary network including a PUF architecture and wherein at least one section of an optical fiber interconnecting the receiver-transmitter and the receivers is an optical fiber with introduced non-fungible noise elements as described below. For simplicity purposes, the PUFs are depicted as fingerprints, but those skilled in the art will understand this graphical depiction as an analogy to a digital fingerprint rather than a literal fingerprint. The network of FIG. 1 includes a receiver-transmitter and a plurality of receivers physically connected with the receiver/transmitter. The terminology receiver-transmitter and receivers are used in relation to the assignment of PUFs and does not relate to or limit the exchange of data and/or messages between the receiver-transmitter and receivers which can of course continue to take place in both upload and download while using the PUFs e.g., encrypted. The receiver-transmitter is equipped with a database of available PUFs, identification of the assigned PUFs and the corresponding receiver of each assigned PUF.

### PUFs Identification

The PUFs generated by the non-fungible noise elements of the optical fiber may be identified by measuring a frequency spectrum or a pulse response pattern of the optical fiber in use. For example, a commercial backscatter reflectometer may be used to measure the frequency spectrum. Bit signature unique to each potential PUF is then computed from the measured frequency spectrum. To satisfy safe encryption requirements, two conditions must be met: 1) the PUF frequency measurements must be repeatable thus identifiable, and 2) each PUF fabricated under the same conditions must return a different result to ensure non-fungibility.

### PUFs Assignment

PUFs are characterized by the number of Challenge-Response Pairs, also known as their CRP domain. Depending on the type of optical fiber used, for example whether a single-mode or a multi-mode optical fiber, the CRP domain may vary greatly, hence the number of PUFs introduced on the optical fiber by the non-fungible noise elements. A PUF interface can be, for example, made publicly available, and authentication could be achieved without resorting to a public/private key cryptographic protocol. However, as the CRP domain of optical fiber based PUFs may sometimes be too large to be completely mapped, even for an issuing server, the authentication protocol can rely on previously observed CRPs for authentication and use each CRP once to avoid compromising security. Therefore, the issuing server must store a sufficiently large CRP table to ensure not running out of challenges [C. Herder, M.-D. Yu, F. Koushanfar, and S. Devadas, “Physical unclonable functions and applications: A tutorial,” Proceedings of the IEEE, vol. 102, no. 8, pp. 1126-1141, 2014]. Optical PUFs [R. Pappu, B. Recht, J. Taylor, and N. Gershenfeld, “Physical one-way functions,” Science, vol. 297, no. 5589, pp. 2026-2030, 2002] and [C. Mesaritakis et al., “Physical unclonable function based on a multi-mode optical waveguide,” Scientific reports, vol. 8, no. 1, pp. 1-12, 2018] and arbiter PUFs [B. Gassend, D. Clarke, M. Van Dijk, and S. Devadas, “Silicon physical random functions,” in Proceedings of the 9th ACM Conference on Computer and Communications Security, 2002, pp. 148-160] are examples of strong PUF architectures.

Other methods of PUFs assignment could alternately used without departing from the scope of the present invention.

### PUFs Operation

After the PUFs assignment is completed, the encryption of data and/or messages between the receiver-transmitter and the receivers starts taking place. The receiver-transmitter receives data or messages for one of the receivers. The receiver-transmitter transmits the received data or message to the intended receiver through the PUF assigned to the intended receiver thereby encrypting the data and/or messages. The encryption of data and/or messages between the receiver-transmitter and the intended receiver is then automatically and physically performed by the PUF without requiring any additional devices. Thus, the encryption of data and/or messages between the receiver-transmitter and the receivers relies on inherent optical properties, and more particularly to non-fungible gratings of the optical fiber therebetween.

The PUF architecture may further include an optical splitter for distributing the PUF encrypted signals generated by the receiver-transmitter to the appropriate receivers depending on their assigned PUF. Alternately, the PUF encrypted signals could be transmitted to many of the receivers and only the portion corresponding to the assigned PUF of each receiver could be decrypted.

Although shown at the distribution level of a network, the present PUF architecture is not limited to such an implementation and could alternately be implemented in any level of networks. Furthermore, multiple sequential PUF architectures could be implemented at different levels of a network.

### Apparatus

U.S. Provisional Application 62/751,951 filed on Oct. 29, 2018, as well as U.S. patent application Ser. No. 16/666,719 filed on Oct. 29, 2019 and issued as U.S. Pat. No. 11,249,248, and U.S. patent application Ser. No. 17/552,473 filed on Dec. 16, 2021 are incorporated herein by reference.

Previous work demonstrated that Random Optical Gratings by Ultraviolet or ultrafast laser Exposure (ROGUEs) could be fabricated by inducing noise in the fabrication process of a uniform fiber Bragg grating [F. Monet, S. Loranger, V. Lambin-lezzi, A. Drouin, S. Kadoury, and R. Kashyap, “The ROGUE: a novel, noise-generated random grating,” Opt. Express, vol. 27, no. 10, pp. 13895-13909, 2019 May 13 2019, doi: 10.1364/OE.27.013895]. To achieve this, a noise signal was added to a meter-long FBG writing station, that was shown to achieve meter-long in-phase FBGs [S. Loranger, V. Lambin-lezzi, and R. Kashyap, “Reproducible ultra-long FBGs in phase corrected non-uniform fibers,” Optica, vol. 4, no. 9, 2017, doi: 10.1364/optica.4.001143]. After further experimentation, the use of such a complex writing station was deemed not necessary to write random gratings and the present apparatus is instead proposed.

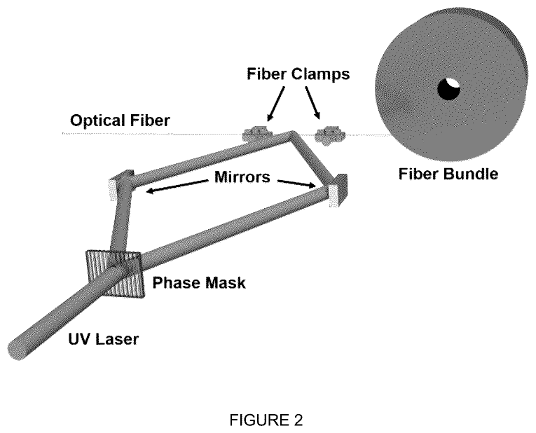

An example of apparatus for producing the present optical fiber is shown on FIG. 2, but the present invention is not limited to the apparatus illustrated. The apparatus shown in FIG. 2 produces non-fungible noise elements, i.e., in this particular example non-fungible gratings, in the optical fiber. The apparatus shown on FIG. 2 relies on ROGUE technology. The apparatus includes a laser in a Talbot interferometer writing scheme (e.g., a combination of microscopic objective, collimating lenses and gratings). The present apparatus is not limited to a Talbot interferometer and any component adapted to introducing non-fungible noise elements along the core of the optical fiber could alternately be used. Furthermore, those skilled in the art that will understand that the selection of laser and type of interferometer could be dependent on the type of optical fiber (single or multi-mode) or optical or mechanical characteristics of the optical fiber to which the non-fungible noise elements are to be introduced.

Furthermore, a central wavelength of a reflection band can be tuned by changing an angle of one or both mirrors thereby modifying an intersection of the two beams.

The optical fiber to be grated is continuously pulled in front of the interference pattern by a stepper motor, which rotates a bundled optical fiber. This allows the writing non-fungible noise elements along an indefinite length of optical fiber. While being pulled by the stepper motor, the optical fiber is held in a focal spot of the laser by two fiber clamps (for example FiberVive™ from PhotoNova Inc.), which are specially designed to allow the optical fiber to slide only in the pulling direction.

However, the present apparatus is not limited to such components. For example, the Talbot interferometer could be replaced by a ‘behind the phase’ mask, a point-by-point inscription or any other component or system which is adapted for introducing non-fungible noise elements to the core of the optical fiber. Also, the UV laser shown on FIG. 2 could be replaced by a femtosecond laser, or any other type of laser adapted for introducing the non-fungible noise elements to the core of the optical fiber.

### Proof of Concept

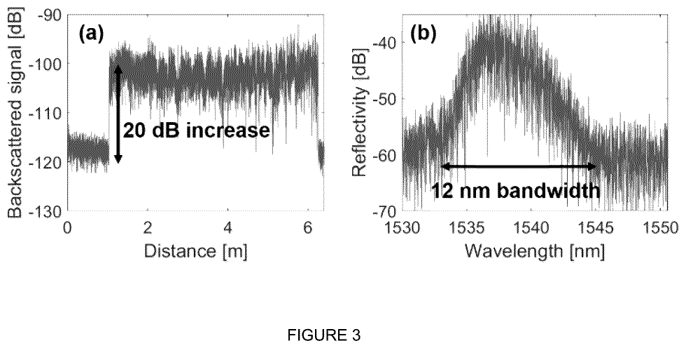

To demonstrate the present concept, non-fungible noise elements (i.e., more particularly gratings in this experiment) were introduced on a 5 meter-long test optical fiber in standard deuterium loaded SMF-28 telecommunications optical fiber. FIG. 3 displays the backscatter and reflection spectra of the test optical fiber.

The non-fungible gratings introduced to the test optical fiber were scanned by a commercial optical backscatter reflectometer (OBR4600, Luna Inc.). The OBR relied on OFDR to measure locally the reflectivity of a piece of optical fiber. The OFDR algorithm relied on a tunable laser, which scanned the optical fiber across a certain bandwidth. At every point along the test optical fiber's length, part of the light was backscattered towards the interrogator, and measured by a photodetector. After the scan was completed, the spectrum of the entire test optical fiber under was generated (similar to the spectrum shown in FIG. 3(b)). An inverse Fourier transform was applied to the spectral data, which resulted in the reflectivity of the test optical fiber in the spatial domain (see FIG. 3(a)). By performing a Fourier transform on specific sections of the overall test optical fiber, their associated spectrum was computed.

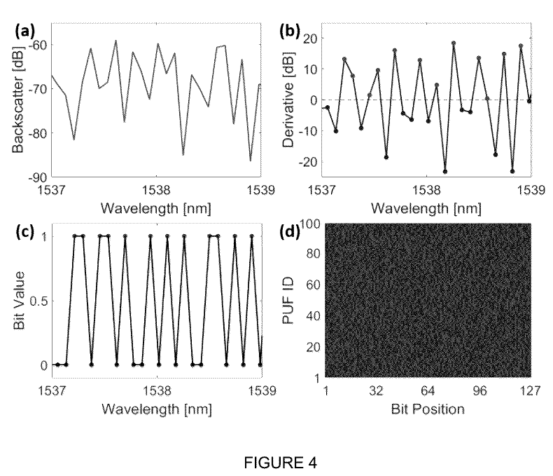

The test optical fiber was subdivided into optical fiber sections, each optical fiber section having its own spectral signature. A 10 mm optical fiber section, corresponding to one PUF, was scanned over a 10 nm bandwidth with the OBR, returned a spectrum with 128 spectral components. This spectrum with 128 spectral components was turned into a digital bit signature by computing the derivative of the spectrum and attributing a 0 or a 1 depending on the sign of the derivative. Signal output for each step of this algorithm was schematized in FIG. 4. The PUF was scanned at a speed of 200 nm/s, meaning the 10 nm bandwidth was scanned in 50 ms. FIG. 4(d) displays the 127-bit signatures of the first 100 PUF generated by this algorithm. No obvious pattern could be observed in the bit signatures, thus proving the non-fungibility of the noise elements introduced to the core of the optical fiber.

### PUF Bit Signature

A bit signature for each PUF generated by the non-fungible noise elements of the optical fiber may be identified by scanning a frequency spectrum or a pulse response pattern for the optical fiber in use. A bit signature unique to each potential PUF is then computed from the scanned frequency spectrum or measured pulse response pattern. For multi-mode optical fibers, the frequency spectrum or the pulse response pattern may be independently computed for each mode. Each bit signature corresponds to one PUF generated by the non-fungible noise elements introduced to the core of the optical fiber. Then, the process computes derivative of the scanned spectrum or scanned pulse response patterns and attributes a 0 or a 1 depending on the sign of the derivate, thereby converting the scanned frequency spectrum or pulse response pattern into a 127-bit signature.

By tuning the scanning parameters, the quality of the results can be further improved. For example, scanning across a larger bandwidth provides a spectrum with more spectral components, which increases the bit sequence length. As such, this increases the security of the PUF, and allows for more error correction capabilities. Alternatively, the PUF's length can be selected to provide the same effect. A 20-mm PUF would have twice as many bits as a 10-mm PUF, all else being equal. To observe the effect those parameters have on the PUF performance, measurements of both intra and inter distributions were realized with different interrogation parameters. In a similar fashion to the analysis described above, a binomial fit was performed to compute false positive and false negative probabilities. To provide a good basis of comparison, the authentication threshold kth used for each of those measurements was the one where the false positive and false negative curves intersect. From those values, we define the false identification probability

P_{FI}=max(P_{FP},P_{FN}). (3)

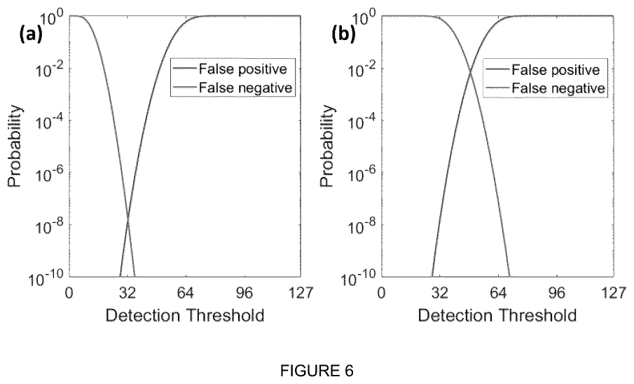

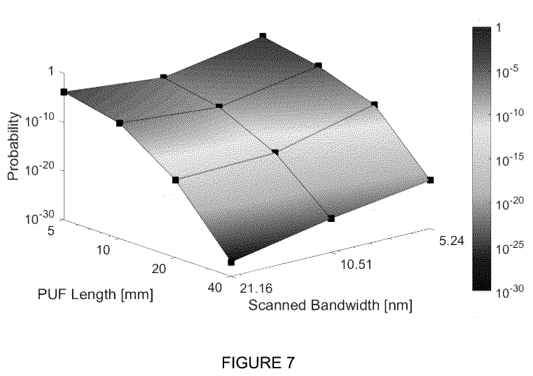

FIG. 7 displays this false identification probability, depending on the interrogation parameters used. Unsurprisingly, adding more bits to the bit sequence, either through a larger scanned bandwidth or through longer PUF lengths, results in decreased false identification probability, due to the larger separation between the intra or inter distributions. However, it can be seen that the effect of those parameters is not the same, namely the use of a longer PUF length has a much more dramatic effect on the false identification probability than the scanned bandwidth. This is because the ROGUE has a limited bandwidth, as shown in FIG. 3(b), therefore using a wider scanned bandwidth dilutes the high SNR data within the ROGUE bandwidth with lower SNR data outside of it. This dilution of the SNR competes with the longer bit sequences originating from the wider scanned bandwidth, resulting in only small improvements in PUF performance. On the other hand, using a longer PUF increases the number of bits in the bit sequence without diluting the SNR, which results in much more dramatic decreases in false identification probability, as can be seen in FIG. 6. Even while using the smallest 5.24 nm scanned bandwidth, the false probability is below 10⁻²⁰, and falls below 10⁻²⁷ while using the broader 21.16 nm bandwidth. To put this in perspective, this is many orders of magnitude greater than the age of the Universe (˜10¹⁶ seconds).

In the methodology discussed so far, the 128 spectral components are turned into a 127-bit sequence by using the sign of each of the 127 components of the discrete derivative to decide if a bit should be a 0 or a 1. This is akin to using the first bit (the sign bit) of a floating-point computer number format (e.g. the single 32-bit or double 64-bit formats) expressing the derivative. However, to achieve an even greater degree of security, it is possible to use more bits than simply the sign bit of the derivative. Furthermore, this alternative removes the need to perform the derivative, since the algorithm can directly use the measured data. This would turn the bit signature length n from (N-1) to m×N, where N is the number of spectral components, and m is the number of bits used per floating-point number. However, depending on the signal, the bits used might change the probabilities p of the intra and inter distributions. Indeed, the bit used must be significant enough to be repeatable through multiple measurements (the intra case), while still being unpredictable from one PUF to the other (the inter case).

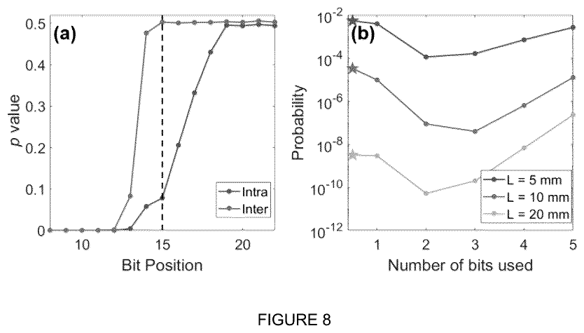

In order to make sure this is indeed the case, the p value was computed for each of the bits of a raw backscattered signal, when expressed in a double 64-bit floating-point computer format, as shown in FIG. 8(a). The first bits are identical for all the PUFs (inter case), since the backscatter is of a similar order of magnitude for all PUFs.

However, as we move towards the least significant bits, it can be seen that the p value of the inter case increases, until the 15^{th} bit where it reaches a value of approximately 0.5, which is the expected value for a randomly varying bit. This is indicated by the dashed line in FIG. 8(a). At the same time, the p value of the intra case remains small, meaning that, while those bits vary randomly between different PUFs, they can still be used to authenticate a single PUF.

To determine how many bits can be used in this fashion, the probability of false identification was computed for bit sequences using up to 5 bits per spectral component. The bits were taken sequentially after the threshold identified in FIG. 7 (a). Since this algorithm is highly dependent on the SNR, only the smallest 5.24 nm scanning bandwidth was used, to ensure that each spectral component profited from the ROGUE's enhancement. FIG. 8(b) displays the evolution of the false identification probability, depending on the number of bits used in the algorithm. For ease of representation, only the three first PUF lengths were shown, although a similar behavior was observed using the 40 mm PUF length (additionally, it could be argued that using this technique is not necessary in the 40 mm PUF case, where the probability of false identification is already below 10⁻²⁰). For comparison, the probability obtained in the previous section is shown with the star marker. When using the first bit of this digitization scheme, the false identification probabilities are similar (and even slightly lower) than the ones obtained by using the derivative algorithm, due to the additional bit that is kept. However, when expanding to 2 or 3 bits per spectral component, it can be observed that the false identification probability can decrease by almost 2 orders of magnitude for each of the investigated lengths. While, as shown in FIG. 6, it may not be necessary to use this enhanced digitization scheme to achieve low false identification probabilities, depending on the interrogation and PUF fabrication schemes, this is an additional tool that can be used in the cases where the initial parameters cannot provide sufficiently high performance.

This results in longer bit sequences, which provide additional security, decreasing the false identification probabilities by almost two orders of magnitude. While this enhancement may not be necessary for all applications, it is an additional tool which can improve the security achieved by the present non-fungible noise elements introduced in the core of the optical fiber and resulting PUFs. The present optical fiber and resulting PUFs are hardware equivalents of Non-Fungible Tokens (NFTs) and find applications in a variety of scenarios in which authentication is of paramount importance in determining authenticity and ownership.

### Object Equipped Therewith

For physical identification. In additional to use in networks as shown in FIG. 1, the present optical fiber and resulting PUF has many other applications. The present optical may be embedded within a physical object to be secured or authenticated. Examples of physical objects in which the present optical fiber could be embedded include without limitations: a banknote, a payment card, or any other object which is adapted for receiving the optical fiber while permitting light to be injected in the optical light to access the PUF generated thereby. A reading device would be used to illuminate the optical fiber to read the unique PUF pattern reflected, and a software could be used to extract the bit pattern therefrom to confirm validity of the physical object.

The present optical fiber is also interesting for other applications that require secure identification of physical devices. For example, the present optical fiber could be embedded in high value objects with high production volume, to high value objects with low product volume, to custom products, to any product which can be counterfeited, etc.

The present optical fiber could also be embedded in any product that can be scanned by an optical reader to extract from the optical fiber the generated PUF and compute therefrom its bit signature for authentication. The present optical fiber represents a viable solution for use in any product and industry where there is low barrier to integration of fibre and optical readers.

Other example of products in which the present optical fiber could be embedded or integrated include electronic consumer goods: smartphones, laptops, TVs and others devices with a glass screen display would be good candidates as the glass could be used to create invisible gratings. Products such as luxury items, smart textiles or bank notes would seem to also be able to meet these characteristics.

More particularly, the case of bank notes was used as a proof of concept to illustrate the potential opportunity and challenges to implement use of the present optical fiber for securing and/or authenticating physical objects. Bank notes are a high value item and produced at high volume. Moreover, production is based on large high-tech plants to capitalize on complex technologies with significant economies of scale.

### Zero Trust Network

Another area of application for the present optical fiber is in zero trust networks. Zero trust security model is an approach to network security based on verification rather than trust. In such network security model, all users and devices have little to no access privilege and require explicit permission to access resources [https://en.wikipedia.org/wiki/Zero_trust_security_model]. The zero trust security can be achieved through a variety of methods sometimes complemented with a hardware-based security to further the protect transfer keys of and certificate [https://blog.pufsecurity.com/2021/09/30/adopting-puf-to-implement-zero-trust-architecture/]. This approach to cybersecurity architecture is valid for any secure environment and has been pushed by very influential organisations such as the US government [https://www.whitehouse.gov/briefing-room/].

### PUF Performance—Hamming Distance Distributions

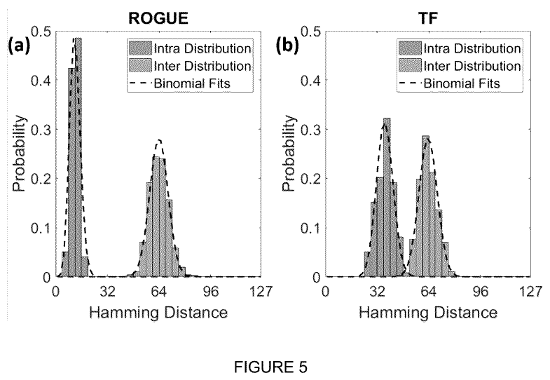

In order to measure the PUFs' performance, two cases were considered. In the first case, the intra case, a single PUF was scanned over 100 successive measurements. The extracted bit signature from the first measurement was compared to the subsequent 99 measurements, and the Hamming distances between the reference and measured signatures were computed. Ideally, to ensure correct authentication, the Hamming distance should be as small as possible, as it represents the number of bits that are incorrectly identified. In the second case, the inter case, the first PUF's signature is compared to 499 different PUFs, which were extracted from the 5-meter long inscribed ROGUE. Again, the Hamming distances between the first PUF and the other 499 were computed. If all PUFs are independently random bit signatures, the Hamming distance will be, on average, half the length of the bit sequence since each bit has a 50% chance of being correct. To provide a basis for comparison, the same measurements were performed on standard SMF-28telecommunications optical fiber (TF), whose signal depends solely on Rayleigh backscatter, instead of the inscribed random structure of the ROGUE. FIG. 5 displays the resulting intra and inter distributions, both for the ROGUE PUFs, as well as for the TF PUFs.

As can be seen in FIG. 5, while the inter distributions for both ROGUE and TF PUFs appear identical and are both centered near 64 bits, the intra distribution of the ROGUE PUFs is much more centered to the left nearer zero than that of its counterpart. This is not surprising, because the higher backscatter provided by the ROGUE increases the signal to noise ratio, making the measurement more repeatable, and thus each PUF is more readily identifiable. However, the inter distributions show that the two PUFs are equally random, since they behave exactly the same way. While the two distributions for the ROGUE PUFs of FIG. 5(a) are well apart and easily distinguishable, we can observe there is a significant overlap of the two histograms for the TF in FIG. 5(b). This is problematic, as it means that it is possible that the correct PUF could be rejected, or alternatively that an intruder could be wrongly authenticated.

### False Positive and Negative Probabilities

To quantify these probabilities, a theoretical fit was performed on the experimentally measured histograms. If each bit of the 127-bit signature of the PUF has a probability p of being incorrect, and that the probability of a given bit to be correct is independent of the probability of the others, then the Hamming distance H between two bit sequences is expected to follow a binomial distribution such that H˜B (n, p), with n the number of bits in the sequence [16]. The probability of measuring a certain Hamming distance k is given by the probability mass function

$$P ( H = k ) = ( \begin{matrix}n \\ k\end{matrix} ) {p}^{k} {( 1 - p )}^{n - k} . \qquad ( 1 )$$

In the inter case, p is expected to be 0.5 since, in two random independent bit sequences, each bit has an equal probability of being either correct or incorrect. As can be seen in FIG. 5, the measured distribution of H has a good match with the theoretical binomial distribution B(127, 0.5), shown in the dashed line, in both cases of the ROGUE and TF, respectively. A binomial distribution fit was also performed in the intra case. This resulted in p values of respectively 0.091 and 0.286 for the ROGUE and TF PUFs.

To compute the probabilities of wrongly authenticating the incorrect user (false positive), or of wrongly rejecting the correct user (false negative), a Hamming distance authentication threshold Kth must be set. Therefore, if the measured Hamming distance is below the threshold, the user is authenticated, and if it is above the threshold, the user is rejected. From the fitted distributions, and depending on the threshold, the probabilities of false positive P_{FP} and false negative P_{FN} can be calculated using

$${P}_{FP} = {\sum }_{k = 0}^{{k}_{th}} P ( H = k ) , \qquad ( 2. a )$$

$${P}_{FN} = {\sum }_{k = {k}_{th} - 1}^{n} P ( H = k ) . \qquad ( 2. b )$$

FIG. 6 displays those values, for both the ROGUE and the TF. Ideally, both values should be as low as possible, therefore it makes sense to look at the intersection of those two curves For the ROGUE PUFs, this threshold would be at a Hamming distance of kₜₕ=32, which results in false positive and false negative rates of respectively 0.01 and 0.02 ppm (parts per million). For the TF, this threshold obviously has to be higher, at 49, which results in probabilities of respectively 8,000 and 5,000 ppm, more than five orders of magnitude greater than that of the ROGUE PUFs.

While a false positive probability of 0.01 ppm is very low, for certain applications it may be insufficient. However, as FIG. 6 displays, it is possible to choose a threshold that is lower than 32, which would further decrease the false positive probability, at the cost of raising the false negative probability. For instance, in situations such as if this key protected nuclear warheads, it may be preferable to have an even lower probability of wrongly authenticating an intruder. In this case, a threshold kₜₕ=24 for example could be picked, which would provide a false positive probability of less than 1 part per trillion (0.45 ppt). In this scenario, if a single scan took 1 second to authenticate, it would take more than 48,000 years to have a 50% chance of fooling this algorithm by brute force. This would come at the cost of an increase to 171 ppm of the probability of false negative, meaning in some rare instances, the correct user could be wrongly rejected. However, this could be mitigated by allowing for example the user two or three attempts at authentication (which would at the same time further limit the ability to break through the system by brute force).

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. An optical fiber comprising:
a core including non-fungible noise elements along a length thereof,
wherein the non-fungible noise elements generate in use a Physical Unclonable Function (PUF).

2. The optical fiber of claim 1, wherein the non-fungible noise elements comprise at least one of: non-fungible grating inscriptions, enhanced scatter through laser exposure and enhanced scatter through nanoparticles doping.

3. The optical fiber of claim 2, wherein the non-fungible grating inscriptions and the enhanced scatter through laser exposure are introduced by one of a UV laser or femtosecond laser.

4. The optical fiber of claim 1 is one of the following: a single mode optical fiber, a multi-mode optical fiber.

5. The optical fiber of claim 1, wherein the non-fungible noise elements are introduced to the core by Random Optical Gratings by Ultraviolet or ultrafast laser Exposure (ROGUE) interference pattern.

6. The optical fiber of claim 5, wherein the ROGUE interference pattern is introduced by at least one of: a Talbot interferometer, behind a phase mask and point-by-point inscription.

7. The optical fiber of claim 6, wherein the ROGUE interference pattern is introduced using one of a UV laser and a femtosecond laser.

8. The optical fiber of claim 1, wherein the optical fiber is a telecommunications optical fiber.

9. The optical fiber of claim 1, wherein a 10 mm optical fiber section generates one PUF.

10. An object including the optical fiber of claim 1.

11. Use of the optical fiber of claim 1 for any of the following applications: authentication, encryption and zero trust security.

12. An apparatus for introducing non-fungible noise elements along a core of a bundled optical fiber, the apparatus comprising:
a laser for generating a light signal;
an interferometer for splitting the light signal into two concurrent light beams;
a pair of mirrors for redirecting the two concurrent light beams to form a ROGUE interference pattern;
a pair of optical fiber clamps, one of the optical fiber clamps being positioned before the ROGUE interference pattern and the other optical fiber clamp being positioned after the ROGUE interference pattern, the pair of optical fiber clamps allowing sliding of the optical fiber along a pulling direction while maintaining the optical fiber located between the pair of optical fiber clamps at a focal spot of the ROGUE interference pattern; and
a stepper motor to pull the optical fiber through the pair of clamps.

13. The apparatus of claim 12, where the laser is one of an ultraviolet laser and a femtosecond laser.

14. The apparatus of claim 12, wherein a central wavelength of the ROGUE interference pattern is tuned by changing an angle of intersection of the two light beams.

15. A method for extracting a digital signature of a Physical Unclonable Function (PUF) generated by introduced non-fungible noise elements in an optical fiber, the method comprising:
injecting light and scanning a frequency spectrum of the optical fiber;
collecting light reflected by the non-fungible noise elements; and
extracting a digital signature for the PUF by:
computing derivative of the collected light over the scanned spectrum; and
attributing a 0 or a 1 depending on the sign of the derivative thereby converting the scanned frequency spectrum into the digital signature.

16. A network comprising:
an optical fiber for transmitting data between a transmitter and a receiver, at least one section of the optical fiber having non-fungible noise elements introduced generating in use a Physical Unclonable Functions (PUFs);
a PUFs database, the database including a list of identified PUFs along the section of optical fiber, and receiver information and assigned PUFs.

17. The network of claim 16, further comprising an optical splitter for distributing PUF encrypted signals to appropriate receivers.
